(19) United States
(12) Patent Application Publication
(10) Pub. No.: US 2025/0070135 A1
(43) Pub. Date: Feb. 27, 2025

(54) LITHIUM-RICH MANGANESE-BASED POSITIVE ELECTRODE MATERIAL, PREPARATION METHOD THEREFOR AND APPLICATION THEREOF

(71) Applicants: INSTITUTE OF PROCESS ENGINEERING, CHINESE ACADEMY OF SCIENCES, Beijing (CN); LANGFANG TECHNOLOGICAL SERVICE CENTER OF GREEN INDUSTRY, Langfang (CN)

(72) Inventors: Qiangqiang TAN, Beijing (CN); Yuxing XU, Beijing (CN)

(73) Assignees: INSTITUTE OF PROCESS ENGINEERING, CHINESE ACADEMY OF SCIENCES, Beijing (CN); LANGFANG TECHNOLOGICAL SERVICE CENTER OF GREEN INDUSTRY, Langfang, HE (CN)

(21) Appl. No.: 18/724,416

(22) PCT Filed: Jun. 29, 2022
(86) PCT No.: PCT/CN2022/102126

§ 371 Date: Jun. 26, 2024

(30) Foreign Application Priority Data
Dec. 29, 2021 (CN) 202111644191.1
Mar. 9, 2022 (CN) 202210226301.0

(51) Int. Cl. H01M 4/36; C01B 32/194; C01G 53/00; H01M 4/485; H01M 4/505; H01M 4/58; H01M 4/587; H01M 4/62; H01M 10/0525

(52) U.S. Cl. CPC H01M 4/366; C01B 32/194; C01G 53/50; H01M 4/364; H01M 4/485; H01M 4/505; H01M 4/5815; H01M 4/587; H01M 4/622; H01M 4/625; H01M 4/628; H01M 10/0525; C01P 2002/50; C01P 2004/32; C01P 2004/84; C01P 2006/40

(57) ABSTRACT

Disclosed in the invention are a lithium-rich manganese-based positive electrode material, a preparation method therefor and an application thereof. The lithium-rich manganese-based positive electrode material comprises a lithium-rich manganese-based positive electrode material core and a shell coated on the surface of the core. The shell comprises a first coating and a second coating. The first coating comprises a composite oxide of Al, Zr, Ce and La and an n-type thermoelectric material. The second coating comprises a composite carbon material, a hydrogen-containing lithium titanium oxide compound and molybdenum disulfide. The lithium-rich manganese-based positive electrode material of the present application has excellent specific discharge capacity, rate capability and cycle stability, and has broad application prospects.

### TECHNICAL FIELD

Embodiments of the present application relate to the technology of preparing lithium-ion battery cathode materials and the field of lithium-ion batteries, for example, a lithium-rich manganese-based cathode material and a preparation method therefor and use thereof.

### BACKGROUND

As environmental and energy problems become more and more serious, electricity, as a clean energy, has gradually replaced fossil energy sources in daily transportation and energy storage. For example, lots of countries have begun to map the technical scheme of pure electric vehicles replacing fuel vehicles, and increase policy support to encourage the rapid development of new energy vehicles. However, at present, electric vehicles cannot completely replace fuel vehicles, because of the shortages in energy storage devices and power source, i.e., the problems of lithium-ion batteries of low energy density and low power density and short cycle life. The improvement of energy density of lithium-ion batteries fundamentally lies in the improvement of specific capacity density of anode and cathode materials, and thus it is especially important to develop anode and cathode materials with high specific capacity density. In particular, lithium-ion battery cathode materials, which account for about 40% of the cost of power batteries, are the soul of power batteries and also the core technology impacting the upgrading of power batteries. Therefore, the development of high-performance and low-cost new cathode materials is one of the efficient paths to further reduce the cost of lithium batteries and enhance competitiveness.

Currently, most of commercial lithium-ion battery cathode materials have a discharge specific capacity of less than 200 mAh/g, and accordingly the energy density of lithium-ion batteries cannot break the barrier of 300 Wh/kg. Lithium-rich manganese-based cathode materials can reach a specific capacity of 250 mAh/g, and is the preferred material for power batteries to achieve high energy density. However, lithium-rich manganese-based cathode materials have many problems in application; for example, the irreversible capacity is high and the initial Coulombic efficiency (<80%) is low during the charge/discharge cycle, which is not conducive to the design of the cathode/anode capacity ratio of lithium-ion cells; the rate capability is poor, which cannot satisfy the high-power charge/discharge requirements of power batteries; and the voltage degradation is serious during the cycling, which leads to the low discharging voltage of power batteries and causes large energy losses. Aiming at the above problems, in-depth research has been carried out on the lithium-rich manganese-based cathode materials by means of coating modification, doping and the like. For example, CN111916728A discloses an electrochemical doping method for a lithium-rich manganese-based cathode material; a battery is obtained by assembling a cathode of the lithium-rich manganese-based cathode material as an active material, an electrolyte comprising an alkali metal salt, and an anode together; and the doping effect is adjusted by controlling the concentration of the alkali metal salt, the temperature of the battery, and the charging and discharging conditions. Compared with the related technology, the alkali metal salt is added to the electrolyte and the alkali metal will enter the lithium-rich manganese-based cathode material in the discharge process and dope into the lithium layer due to the concentration diffusion, Brownian motion, etc.; hence, using the pillar effect of the alkali metal ion with large radius as well as its blocking effect on transition metal ions from entering tetrahedral interstices, the voltage degradation of the lithium-rich manganese-based cathode material is alleviated during the cycling process, and thus the rate capability of the material is improved. However, this method lacks universal operability in the practical application and is not easy to be applied in large-scale industrialization, and such chemical doping has limited improvements on electrochemical performance and is unsuitable for large-scale promotion. Therefore, researchers have used coating and other methods to enhance the electrochemical performance of lithium-rich manganese-based cathode material. For example, Yu R. et al. (Acs Applied Materials & Interfaces, 2017, 9:41210-41223.) used Li4Mn5O12 for surface coating; the Coulombic efficiency of the material reaches 90.5%, and the discharge specific capacity is 273.8 mAh/g after 200 cycles at 0.4C, but this kind of coating cannot inhibit the surface side reactions and structural transformation of lithium-rich manganese-based cathode material. Song B. et al. (Journal of Materials Chemistry A, 2013, 1.) and Jiang K.-C. et al. (Acs Applied Materials & Interfaces, 2012, 4(9):4858-4863.1) used graphene to coat the lithium-rich manganese-based cathode material; the rate capability of the materials is improved, and the discharge specific capacities of the materials at 10C and 3C reach 201 mAh/g and 120 mAh/g, respectively; however, the material employing this coating method is prone to uneven coating and also corrosion and oxidization by the electrolyte, thus being affected in the comprehensive electrochemical performance. Kobayashi G. et al. (Journal of Power Sources, 2016, 303:250-256.) used Al2O3 to coat a lithium-rich manganese-based cathode material, and although the cycling stability of the material at high temperatures can be improved, the influence of the final product on the material performance and coating thickness cannot be precisely regulated.

### SUMMARY

The following is a summary of the subject matter described in detail herein. This summary is not intended to limit the protection scope of the claims.

Examples of the present application provide a lithium-rich manganese-based cathode material and a preparation method therefor and use thereof. The high-performance lithium-rich manganese-based cathode material provided by the present application has excellent discharge specific capacity, rate capability and cycling stability. For the lithium-ion battery assembled by the high-performance lithium-rich manganese-based cathode material, the discharge specific capacity can reach up to 283 mAh/g at a current density of 30 mA/g, and reach up to 142 mAh/g at a 5C rate, and the capacity retention can reach up to 87% after 150 cycles, showing a promising application prospect.

In a first aspect, embodiments of the present application provide a lithium-rich manganese-based cathode material, and the lithium-rich manganese-based cathode material comprises a lithium-rich manganese-based cathode material core and a shell coated on the surface of the core, the shell comprises a first coating material and a second coating material, the first coating material comprises a Al—Zr—Ce—La complex oxide and an n-type thermoelectric material, and the second coating material comprises a composite carbon material, a hydrogen-containing lithium-titanium-oxygen compound and molybdenum disulfide.

For the cathode material of the present application, the Al—Zr—Ce—La complex oxide as the first coating material can not only facilitate the denser surface morphology of the material, but also bring the material a more stable crystal structure, which is beneficial for the material to resist a series of adverse influences brought by structural degradation during long charging-discharging cycles, improves the lithium-rich manganese-based cathode material in cycling stability and ultimately endow it with superior electrochemical performance.

The use of coating layer containing the n-type thermoelectric material can convert heat generated by the lithium-rich manganese-based cathode material via metastable path into a local electric field during the charging-discharging cycling process, undermine the driving force on the structural transformation of the lithium-rich manganese-based cathode material during the cycling process, improve the structural stability of the lithium-rich manganese-based cathode material, and in turn improve the electrochemical performance and cycling life.

The second coating material on the surface of the lithium-rich manganese-based cathode material provide more lithium-ion transport channels, and the coating layer having the composite carbon material can optimize the contact impedance between the active particles of cathode material, and improve the cathode material in the initial discharging capacity, rate capability, and cycling stability.

Examples of the present application do not limit the mode of distribution of the first coating material and the second coating material. In an embodiment, the first coating material may form a first coating layer on the surface of the core, and then the second coating material may form a second coating layer on the surface of the first coating layer. In the embodiment, the first coating layer may be coated completely or partially; the second coating layer may be coated completely or partially.

In another embodiment, the first coating material and the second coating material may be directly mixed with each other and form an integrated coating layer on the surface of the core. Preferably, the lithium-rich manganese-based cathode material core has a structural formula of xLi2MnO3·(1−x)LiMO2, wherein M is any one or a combination of at least two of Co, Ni, Fe, K, V, Cr, Ge, Nb, Mo, Zr, Al, Sr, Mg, Ti or Mn, and 0<x≤1, for example, x is 0.1, 0.2, 0.3, 0.4, 0.5, 0.6, 0.7, 0.8, 0.9 or 1.0.

Preferably, M is a combination of Co, Ni and Mn.

Preferably, the lithium-rich manganese-based cathode material is spherical and/or spheroidal.

Preferably, in the lithium-rich manganese-based cathode material, the lithium-rich manganese-based cathode material core is a primary particle, and the primary particle has a shell coated on its surface; the primary particle forms a secondary particle by spray drying. Preferably, in the lithium-rich manganese-based cathode material, the second coating material having a three-dimensional network structure is uniformly coated on the surface of the primary particle and/or between the primary particles. It is to be understood that the coating materials existing on the surface of the primary particle and/or between the primary particles include not only the second coating material but also the first coating material.

The second coating material uniformly distributed on the surface of the lithium-rich manganese-based cathode material has a network structure, and can effectively improve the reaction at the electrode/electrolyte interface, inhibit the growth of the solid electrolyte interphase (SEI) of the electrode and slow down the polarization of the electrode. Moreover, the conductive network inside the material reduces the internal resistance between primary particles and accelerates the charge transfer process of the electrode.

Preferably, based on a mass of the lithium-rich manganese-based cathode material being 100%, a mass of the first coating material is 0.01-3%, such as 0.01%, 0.05%, 0.1%, 0.2%, 0.3%, 0.5%, 0.6%, 0.7%, 1%, 1.2%, 1.5%, 1.7%, 2%, 2.3%, 2.5%, 2.8% or 3%.

Preferably, based on a mass of the lithium-rich manganese-based cathode material being 100%, a mass of the second coating material is 0.01-5%, such as 0.01%, 0.05%, 0.1%, 0.2%, 0.3%, 0.5%, 0.6%, 0.7%, 1%, 1.2%, 1.5%, 1.7%, 2%, 2.3%, 2.5%, 2.8%, 3%, 3.2%, 3.4%, 3.7%, 4%, 4.3%, 4.5%, 4.8% or 5%.

Preferably, in the first coating material, a mass ratio of the Al—Zr—Ce—La complex oxide and the n-type thermoelectric material is (0.01-0.5):1, such as 0.01:1, 0.03:1, 0.05:1, 0.08:1, 0.1:1, 0.2:1, 0.3:1, 0.4:1 or 0.5:1.

Preferably, in the Al—Zr—Ce—La complex oxide, a molar ratio of Al, Zr, Ce and La is (4-7):(1-3):(1-2):1, wherein the range (4-7) of Al comprises, for example, 4, 5, 6, 6.5, 7, etc., the range (1-3) of Zr comprises, for example, 1, 1.5, 2, 3, etc., and the range (1-2) of Ce comprises, for example, 1, 1.2, 1.5, 2, etc.

Preferably, the n-type thermoelectric material has ion channels.

Preferably, the n-type thermoelectric material comprises any one or a combination of at least two of LiaPbNbO2, (Nd⅔-cLi3c)TiO3, (La⅔-dLi3d)TiO3 or CaeBifMnO3, wherein 0<a<0.4, 0<b<0.2, 0.2<c<⅔, 0.2<d<⅔, 0.5<e.5< and 0 an<0.5. Exemplarily, a is, for example, 0.1, 0.2, 0.3, or 0.4, b is, for example, 0.01, 0.05, or 0.08, c is, for example, 0.3, 0.4, or 0.5, d is, for example, 0.3, 0.4, or 0.5, e is, for example, 0.6, 0.7, 0.8, 0.9, or 1, and f is, for example, 0, 0.1, 0.2, 0.3, or 0.4.

Preferably, the second coating material has a three-dimensional network structure.

Preferably, in the second coating material, the composite carbon material is a conductive polymer/graphene/carbon nanotube composite material.

Preferably, in the conductive polymer/graphene/carbon nanotube composite material, a mass ratio of a conductive polymer, graphene, and carbon nanotubes is (1-3):(2-5):(2-7), wherein the range (1-3) of the conductive polymer comprises, for example, 1, 2, 2.5, or 3, the range (2-5) of the graphene comprises, for example, 2, 3, 3.5, 4, or 5, and the range (2-7) of the carbon nanotubes comprises, for example, 2, 3, 4, 5, 6, or 7.

Preferably, in the conductive polymer/graphene/carbon nanotube composite material, the conductive polymer comprises any one or a mixture of at least two of polypyrrole, polyaniline or polythiophene, or a copolymer formed from monomers of at least two of the conductive polymers.

Preferably, in the conductive polymer/graphene/carbon nanotube composite material, the graphene is formed by chemical reduction of graphene oxide.

Preferably, in the conductive polymer/graphene/carbon nanotube composite material, the carbon nanotubes are any one of single-walled carbon nanotubes or multi-walled carbon nanotubes, or a combination thereof.

Preferably, in the conductive polymer/graphene/carbon nanotube composite material, the carbon nanotubes are hydroxylated carbon nanotubes.

Preferably, in the conductive polymer/graphene/carbon nanotube composite material, the carbon nanotubes are hydroxylated multi-walled carbon nanotubes.

Preferably, the hydroxylated multi-walled carbon nanotubes have an inner diameter of 5-12 nm, such as 5 nm, 6 nm, 8 nm, 10 nm or 12 nm, preferably 6-10 nm.

The hydroxylated multi-walled carbon nanotubes have a length of 1 nm-60 nm, such as 1 nm, 3 nm, 5 nm, 6 nm, 8 nm, 10 nm, 12 nm, 15 nm, 18 nm, 20 nm, 23 nm, 25 nm, 28 nm, 30 nm, 33 nm, 36 nm, 40 nm, 45 nm, 50 nm, 55 nm, or 60 nm, preferably 1 nm-50 nm, and further preferably 1 nm-40 nm.

Preferably, the conductive polymer/graphene/carbon nanotube composite material is obtained by in situ polymerization.

Preferably, in the second coating material, the hydrogen-containing lithium-titanium-oxygen compound is a compound formed by the four elements of Li, H, Ti and O in any ratio.

Preferably, the hydrogen-containing lithium-titanium-oxygen compound is a compound whose phase structure contains Li4Ti5O12, TiO2 and HxTiyOz phases in any ratio, preferably a compound whose phase structure contains Li4Ti5O12 and H2Ti3O7·(H2O·3TiO2) phases in any ratio, wherein 0<x≤2, 0<y≤3, and 0<z≤7.

Preferably, the hydrogen-containing lithium-titanium-oxygen compound is Li1.81H0.19Ti2O5·mH2O, wherein m>0.

Preferably, the hydrogen-containing lithium-titanium-oxygen compound and/or molybdenum disulfide is dispersed in situ on the surface of the composite carbon material.

Preferably, a mass ratio of the composite carbon material, the hydrogen-containing lithium-titanium-oxygen compound, and the molybdenum disulfide is (2-6):(3-5):(1-5), wherein the range (2-6) of the composite carbon material comprises, for example, 2, 3, 4, 5, or 6, the range (3-5) of the hydrogen-containing lithium-titanium-oxygen compound comprises, for example, 3, 4, 4.5, or 5, and the range (1-5) of the molybdenum disulfide comprises, for example, 1, 2, 3, 4, or 5.

Preferably, at least one of the composite carbon material, the hydrogen-containing lithium-titanium-oxygen compound and the molybdenum disulfide is doped with nitrogen, and preferably, the composite carbon material, the hydrogen-containing lithium-titanium-oxygen compound and the molybdenum disulfide are all doped with nitrogen.

Preferably, the first coating material is coated on the surface of the core;
the second coating material is coated on the surface of the first coating material, or the second coating material is coated on the surface of the first coating material and the surface of the core.

In a second aspect, embodiments of the present application provide a method for preparing the lithium-rich manganese-based cathode material as described in the first aspect, and the method comprises the following steps:
(1) preparing a composite sol of Al, Zr, Ce and La in accordance with a stoichiometric ratio, and adding a lithium-rich manganese-based cathode material and an n-type thermoelectric material to the composite sol, so as to obtain a first slurry;
(2) subjecting the first slurry to spray drying and then heat treatment to coat a first coating material on the surface of a lithium-rich manganese-based cathode material core, so as to obtain a precursor;
(3) dispersing the precursor and a second coating material into a solvent, so as to obtain a second slurry; and
(4) subjecting the second slurry to spray drying, so as to obtain the lithium-rich manganese-based cathode material.

In the method of the examples of the present application, the coating is carried out in two stages by two spray-drying processes. The main reasons and benefits to employ the method lie in that: (1) uniform primary and secondary coating can be realized on the surface of the lithium-rich manganese-based cathode material, and thus the coated lithium-rich manganese-based cathode material can be strengthened against the corrosion of electrolyte during the charging and discharging process, and in turn improved in electrochemical performance; (2) the two spray-drying processes can produce the spherical/spheroidal lithium-rich manganese-based cathode material, improve the tap density of the material, and further improve the volumetric specific energy of the material; and (3) the second coating material with the three-dimensional network structure is more easily to be uniformly coated on the surface of the primary particle and between the particles inside the spherical/spheroidal lithium-rich manganese-based cathode material, which shortens the lithium-ion transport distance in the charging and discharging process, and increases the electrical conductivity, discharge specific capacity and rate capability of the lithium-rich manganese-based cathode material.

In an example of the present application, the lithium-rich manganese-based cathode material in step (1) is subjected to crushing treatment before being added to the composite sol, and a primary particle size of particles obtained from the crushing treatment is preferably 0.1-2 μm, such as 0.1 μm, 0.3 μm, 0.5 μm, 0.7 μm, 1 μm, 1.3 μm, 1.5 μm, 1.7 μm or 2 μm, preferably 0.2-1.5 μm, and further preferably 0.5-1.0 μm.

Preferably, the n-type thermoelectric material in step (1) is subjected to crushing treatment before being added to the composite sol, and a primary particle size of particles obtained from the crushing treatment is preferably 0.1-2 μm, such as 0.1 μm, 0.3 μm, 0.5 μm, 0.7 μm, 1 μm, 1.3 μm, 1.5 μm, 1.7 μm or 2 μm, preferably 0.2-1.5 μm, and further preferably 0.5-1.0 μm.

Preferably, the first slurry in step (1) has a solid content of 40-70%, such as 40%, 42%, 45%, 47%, 50%, 53%, 55%, 58%, 60%, 65% or 70%.

Preferably, the spray drying in step (2) is performed at an inlet temperature of 150-280° C., such as 150° C., 160° C., 180° C., 200° C., 220° C., 250° C., 260° C. or 280° C., and at an outlet temperature of 70-100° C., such as 70° C., 75° C., 80° C., 85° C., 90° C. or 100° C.

Preferably, the spray drying in step (2) is performed in an air atmosphere.

Preferably, the heat treatment in step (2) is performed at a temperature of 450-550° C., such as 450° C., 460° C., 470° C., 480° C., 500° C., 515° C., 530° C. or 550° C.

Preferably, the heat treatment in step (2) is performed for a period of 3-6 h, such as 3 h, 4 h, 5 h or 6 h.

Preferably, in step (3), before or after being dispersed into the solvent, the precursor and the second coating material are treated by a high pressure homogenizer at 50-210 MPa (such as 50 MPa, 70 MPa, 80 MPa, 100 MPa, 130 MPa, 150 MPa, 180 MPa or 200 MPa) for 1-40 min (such as 1 min, 3 min, 5 min, 8 min, 10 min, 13 min, 15 min, 20 min, 25 min, 30 min or 40 min). In the case where the precursor and the second coating material are treated by the high pressure homogenizer before being dispersed into the solvent, the precursor and the second coating material can be separately homogenized by the high pressure homogenizer, or the two materials can be mixed first and then homogenized by the high pressure homogenizer.

Preferably, the solvent in step (3) comprises any one or a combination of at least two of deionized water, anhydrous ethanol, diethyl ether, acetone, tetrahydrofuran, benzene, toluene, N-methylpyrrolidone or dimethylformamide, and preferably any one or a combination of at least two of deionized water, anhydrous ethanol or acetone.

Preferably, the second slurry is subjected to homogenization before the spray drying in step (4).

Preferably, the homogenization is performed by a homogenizing mixer.

Preferably, the homogenization is performed at a pressure of 500-800 Pa, such as 500 Pa, 550 Pa, 600 Pa, 650 Pa, 700 Pa, 750 Pa or 800 Pa.

Preferably, the homogenization is performed for a period of 1-30 min, such as 1 min, 3 min, 5 min, 8 min, 10 min, 13 min, 15 min, 20 min, 25 min or 30 min.

Preferably, the second slurry after the homogenization has a solid content of 45-65%, such as 45%, 47%, 50%, 53%, 55%, 58%, 60% or 65%.

In an example of the present application, before the lithium-rich manganese-based cathode material is coated with the second coating material on the surface, the material to be dispersed is preferably treated using a high-pressure homogenizer; the second slurry, which is obtained by homogenizing the lithium-rich manganese-based cathode material core coated with the first coating material and the second coating material by the high-pressure homogenizer and then dispersing the same into the solvent, by realizing automatic cyclic homogenization under a certain pressure, can maintain the pristine activity and performance of the material, facilitate a more uniform coating of the second coating material on the surface of primary particles of lithium-rich manganese-based cathode material, and form the spheroidal high-performance lithium-rich manganese-based cathode material via the subsequent spray drying. The second coating material having the three-dimensional network structure is uniformly coated on the surface of the spherical/spheroidal inner primary particle and between the particles, which shortens the lithium-ion transport distance in the charging and discharging process, and increases the electrical conductivity, discharge specific capacity and rate capability of the lithium-rich manganese-based cathode material.

Preferably, a step of drying is further performed after the spray drying in step (4), and the drying is performed at a temperature of 70-80° C., such as 70° C., 73° C., 75° C., 77° C. or 80° C.

Preferably, the spray drying in step (4) is performed at an inlet temperature of 150° C.-280° C., such as 150° C., 160° C., 180° C., 200° C., 220° C., 250° C., 260° C. or 280° C., and at an outlet temperature of 70° C.-100° C., such as 70° C., 75° C., 80° C., 85° C., 90° C. or 100° C.

Preferably, the spray drying in step (4) is performed under the protection of a protective gas, and the protective gas comprises any one or a combination of at least two of nitrogen, helium, argon, neon, krypton and xenon.

In an example of the present application, a method for preparing the second coating material in step (3) comprises the following steps:
(a) dispersing graphene into a solvent, performing ultrasonic treatment, adding a conductive polymer monomer, performing ultrasonic treatment, adding an initiator, carbon nanotubes, a hydrogen-containing lithium-titanium-oxygen compound and molybdenum disulfide, and performing polymerization reaction to obtain a product A; and
(b) subjecting the product A in step (a) to separation and then drying, so as to obtain the second coating having a three-dimensional nano-network layered structure which is prepared from the conductive polymer/graphene/carbon nanotube composite material, the hydrogen-containing lithium-titanium-oxygen compound and molybdenum disulfide by in situ polymerization.

Preferably, step (c) is further performed after the drying in step (b) for nitrogen doping of the second coating material, and step (c) is: subjecting the product obtained from step (b) to heat treatment with a gaseous nitrogen source for chemical vapor deposition.

Preferably, the ultrasonic treatment in step (a) is performed at a power of 50 W-600 W, such as 50 W, 70 W, 80 W, 100 W, 150 W, 200 W, 240 W, 280 W, 300 W, 350 W, 400 W, 450 W, 500 W, 550 W or 600 W.

Preferably, the ultrasonic treatment in step (a) is performed for a period of 30 min-2 h, such as 30 min, 45 min, 1 h, 1.5 h or 2 h. The period of ultrasonic treatment here refers to the total period of the ultrasonic treatment in step (a).

Preferably, the conductive polymer monomer in step (a) comprises any one or a mixture of at least two of pyrrole, aniline or thiophene.

Preferably, the solvent in step (a) comprises any one or a mixture of at least two of ethanol, deionized water, inorganic protonic acid or a chloroform solution of ferric chloride.

Preferably, in step (a), the initiator is ammonium persulfate.

Preferably, in step (a), the initiator is added as 0.1 times to 2 times, such as 0.1 times, 0.3 times, 0.5 times, 0.8 times, 1 time, 1.5 times, or 2 times, preferably 0.5 times to 1.5 times, a mass of the polymer monomer added.

Preferably, the polymerization reaction in step (a) is performed in an ice-water bath.

Preferably, the polymerization reaction in step (a) is accompanied by stirring, and the stirring is performed preferably at a rate of 500-3000 r/min, such as 500 r/min, 600 r/min, 700 r/min, 800 r/min, 1000 r/min, 1200 r/min, 1500 r/min, 1700 r/min, 2000 r/min, 2300 r/min, 2500 r/min, or 3000 r/min.

Preferably, the polymerization reaction in step (a) is performed for a period of 12 h-30 h, such as 12 h, 14 h, 15 h, 17 h, 18 h, 20 h, 23 h, 25 h or 27 h.

Preferably, the carbon nanotubes in step (a) are hydroxylated carbon nanotubes, preferably hydroxylated multi-walled carbon nanotubes.

Preferably, the separation in step (b) is centrifugal separation.

Preferably, the drying in step (b) is vacuum drying, and the vacuum drying is performed preferably at a temperature of 50-70° C., such as 50° C., 55° C., 60° C., 65° C. or 70° C.

Preferably, the gaseous nitrogen source in step (c) is ammonia gas.

Preferably, the gaseous nitrogen source in step (c) has a flow rate of 10-500 sccm, such as 10 sccm, sccm, 30 sccm, 50 sccm, 80 sccm, 100 sccm, 150 sccm, 200 sccm, 300 sccm, 350 sccm, or 400 sccm, preferably 20-400 sccm, and further preferably 40-350 sccm.

Preferably, the heat treatment in step (c) is performed at a temperature of 300-700° C., such as 300° C., 350° C., 400° C., 450° C., 500° C., 550° C., 600° C., 650° C. or 700° C., preferably 350-650° C., and further preferably 400-600° C.

Preferably, the heat treatment in step (c) is performed for a period of 0.5-5 h, such as 0.5 h, 1 h, 1.5 h, 2 h, 2.5 h, 3 h, 3.5 h, 4 h or 4.5 h, preferably 0.5-3 h.

Compared with the related art, examples of the present application have the following beneficial effects.

(1) The Al—Zr—Ce—La complex oxide as the first coating material can not only facilitate the denser surface morphology of the material, but also bring the material a more stable crystal structure, which is beneficial for the material to resist a series of adverse influences brought by structural degradation during long charging-discharging cycles, improves the lithium-rich manganese-based cathode material in cycling stability and ultimately endow it with superior electrochemical performance.

(2) The use of coating layer containing the n-type thermoelectric material can convert heat generated by the lithium-rich manganese-based cathode material via metastable path into a local electric field during the charging-discharging cycling process, undermine the driving force on the structural transformation of the lithium-rich manganese-based cathode material during the cycling process, improve the structural stability of the lithium-rich manganese-based cathode material, and in turn improve the electrochemical performance and cycling life.

(3) In an example of the present application, before the lithium-rich manganese-based cathode material is coated with the second coating material on the surface, the material to be dispersed is preferably treated using a high-pressure homogenizer; by realizing automatic cyclic homogenization under a certain pressure, the material can maintain its pristine activity and performance, the second coating material can be more uniformly coated on the surface of primary particles of lithium-rich manganese-based cathode material, and the spheroidal high-performance lithium-rich manganese-based cathode material can be formed via the subsequent spray drying. The second coating material having the three-dimensional network structure is uniformly coated on the surface of the spherical/spheroidal inner primary particle and between the particles, which shortens the lithium-ion transport distance in the charging and discharging process, and increases the electrical conductivity, discharge specific capacity and rate capability of the lithium-rich manganese-based cathode material.

(4) The second coating material uniformly distributed on the surface of the lithium-rich manganese-based cathode material has a network structure, and can effectively improve the reaction at the electrode/electrolyte interface, inhibit the growth of the solid electrolyte interphase (SEI) of the electrode and slow down the polarization of the electrode. Moreover, the conductive network inside the material reduces the internal resistance between primary particles and accelerates the charge transfer process of the electrode.

(5) The second coating material on the surface of the lithium-rich manganese-based cathode material provide more lithium-ion transport channels, and the coating layer having the composite carbon material can optimize the contact impedance between the active particles of cathode material, and improve the cathode material in the initial discharging capacity, rate capability, and cycling stability.

Other aspects can be understood upon reading and appreciating the detailed description.

### DETAILED DESCRIPTION

The technical solutions of the present application are further described below in terms of specific embodiments.

In order to better illustrate the present application and facilitate the understanding of the technical solutions of the present application, the present application is described below in further details. However, the following embodiments are only simple examples of the present application and do not represent or limit the protection scope of the present application. The protection scope of the present application is defined by the claims.

In examples of the present application, the composite sol can be prepared by conventional methods in the field, which should be selected according to the specific metal elements. The sol preparation can employ citric acid as a ligand or employ organic salts of the metal elements or other methods. For example, the composite sol of the four elements Al, Zr, Ce and La is prepared by a method where a soluble salt solution of the metal elements is added with citric acid as a ligand for complexation: an aqueous solution with a certain concentration is prepared from aluminum nitrate, zirconium nitrate, cerium nitrate and lanthanum nitrate in accordance with a stoichiometric ratio, citric acid is added as a ligand by twice the total molar amount of the metal elements, and the system is adjusted to a H+concentration of about 0.1 mol/L by nitric acid and rapidly stirred until a transparent composite sol is generated.

For the space limitation and concision reason, the methods for preparing the sol containing the metal M element will not be enumerated exhaustively.

The following are typical but non-limiting examples of the present application.

### Example 1

(1) A lithium-rich manganese-based cathode material was prepared according to a molecular formula of Li1.2Mn0.6Ni0.15Co0.05O2, and an n-type thermoelectric material was prepared according to a molecular formula of Li0.3P0.1NbO2.

(2) Preparation of second coating material:

Graphene was dispersed into anhydrous ethanol, subjected to ultrasonic treatment at a power of 600 W, added with a pyrrole monomer, and subjected to ultrasonic treatment again until the total period of ultrasonic treatment reached 30 min; the dispersion system was added with ammonium persulfate as an initiator which was 0.1 times the mass of pyrrole monomer, hydroxylated multi-walled carbon nanotubes with an inner diameter of 5 nm and a length of 60 nm, a hydrogen-containing lithium-titanium-oxygen compound of Li1.81H0.19Ti2O5·H2O, and molybdenum disulfide, then subjected to polymerization reaction in an ice-water bath for 12 h accompanied by stirring at a rate of 500 r/min, and dried under vacuum at 70° C. to obtain a coating material having a three-dimensional nano-network layered structure which was prepared from the polypyrrole/graphene/carbon nanotube composite material, the hydrogen-containing lithium-titanium-oxygen compound of Li1.81H0.19Ti2O5·H2O and molybdenum disulfide by in situ polymerization. The product B was subjected to heat treatment at 600° C. for 1 h with ammonia gas as a nitrogen source at a flow rate of 500 sccm for chemical vapor deposition to obtain a second coating material. In the second coating material, a mass ratio of the polypyrrole, graphene, and carbon nanotubes was 1:2:7, and a mass ratio of the nitrogen-doped composite carbon material, nitrogen-doped hydrogen-containing lithium-titanium-oxygen compound, and nitrogen-doped molybdenum disulfide was 6:3:1.

(3) Preparation of high-performance lithium-rich manganese-based cathode material:

A composite sol of Al, Zr, Ce and La was prepared in accordance with a molar ratio of Al, Zr, Ce and La being 4:1:1:1, and Li1.2Mn0.6Ni0.15Co0.05O2 and Li0.3P0.1NbO2 with primary particle sizes of 0.1 μm were added to the composite sol and rapidly stirred uniformly to form a slurry C with a solid content of 40%;

the slurry C was subjected to spray drying and then to heat treatment at 550° C. for 3 h, and the lithium-rich manganese-based cathode material core obtained a first coating layer on its surface, so as to obtain a product D.

The product D and the second coating material were dispersed into anhydrous ethanol by stirring to form a mixed slurry E. The mixed slurry E was pumped into a high-pressure homogenizing mixer at a pressure of 500 Pa and homogenized at a pressure of 100 MPa for 30 min to obtain a mixed slurry F with a solid content of 65%. The mixed slurry F was spray-dried in a spray-drying machine, and then sufficiently dried at 80° C. to obtain the target product, i.e., the high-performance lithium-rich manganese-based cathode material.

In steps (1)-(3), based on a mass of the lithium-rich manganese-based cathode material being 100%, a mass of the first coating material was 0.01%, and a mass of the second coating material was 5%. A mass ratio of the Al—Zr—Ce—La complex oxide and the n-type thermoelectric material was 0.01:1.

(4) Electrochemical performance test:

a. The high-performance lithium-rich manganese-based cathode material, conductive carbon black (Super P) and a binder (PVDF) were separately weighed out according to a mass ratio of 97:1:2, and prepared into a cathode slurry with NMP as a solvent by being magnetically stirred for 8 h.

b. The cathode slurry was coated on an aluminum foil with a thickness of 200 μm by a coating machine, dried at 100° C. for 6 h, then repeatedly rolled for 5 times by a double-roller press with a roller gap set as 70 μm, and then transferred to a vacuum drying box and dried at 120° C. for 12 h to remove the NMP and residual water completely.

c. The dried electrode was cut into a disc of 14 mm diameter, i.e., a working electrode.

d. Assembling of button cell: with a lithium plate used as a negative electrode, Celgard2500 polypropylene separator used as a separator, and 1 mol/L LiPF6 (containing DMC+EC+DMC at a volume ratio of 1:1:1) used as an electrolyte, a CR2032 button cell was assembled in a glove box filled with dry argon, and at the same time, the concentration of water and oxygen in the glove box was controlled to be less than 1 ppm. e. The button cell was aged in standing still for 12 h, and then subjected to charging/discharging test on the Arbin battery test system with a voltage range of 2.0-4.8 V. It was learned from the test and analysis that the high-performance lithium-rich manganese-based cathode material prepared in this example had a discharge specific capacity of 283 mAh/g at a current density of 30 mA/g, a discharge specific capacity of 142 mAh/g at a 5C rate, and a capacity retention of 87% after 150 cycles, showing excellent electrochemical performance.

Unless otherwise specified, the electrochemical test methods in the examples of the present application are all same as in this example.

### Example 2

(1) A lithium-rich manganese-based cathode material was prepared according to a molecular formula of Li1.2Mn0.55Ni0.15Co0.1O2, and an n-type thermoelectric material was prepared according to a molecular formula of (Nd⅓Li)TiO3.

(2) Preparation of second coating material: Graphene was dispersed into a chloroform solution of ferric chloride, subjected to ultrasonic treatment at a power of 50 W, added with an aniline monomer, and subjected to ultrasonic treatment again until the total period of ultrasonic treatment reached 2 h; the dispersion system was added with ammonium persulfate as an initiator which was 2 times the mass of aniline monomer, hydroxylated multi-walled carbon nanotubes with an inner diameter of 12 nm and a length of 50 nm, a hydrogen-containing lithium-titanium-oxygen compound of Li1.81H0.19Ti2O5·2H2O, and molybdenum disulfide, then subjected to polymerization reaction in an ice-water bath for 30 h accompanied by stirring at a rate of 3000 r/min, and dried under vacuum at 50° C. to obtain a coating material having a three-dimensional nano-network layered structure which was prepared from the polyaniline/graphene/carbon nanotube composite material, the hydrogen-containing lithium-titanium-oxygen compound of Li1.81H0.19Ti2O5·2H20 and molybdenum disulfide by in situ polymerization. The product B was subjected to heat treatment at 700° C. for 0.5 h with ammonia gas as a nitrogen source at a flow rate of 10 sccm for chemical vapor deposition to obtain a second coating material. In the second coating material, a mass ratio of the polypyrrole, graphene, and carbon nanotubes was 3:5:2, and a mass ratio of the nitrogen-doped composite carbon material, nitrogen-doped hydrogen-containing lithium-titanium-oxygen compound, and nitrogen-doped molybdenum disulfide was 2:3:5.

(3) Preparation of high-performance lithium-rich manganese-based cathode material: A composite sol of Al, Zr, Ce and La was prepared in accordance with a molar ratio of Al, Zr, Ce and La being 7:3:2:1, and Li1.2Mn0.55Ni0.15Co0.1O2 and (Nd⅓Li)TiO3 with primary particle sizes of 2 μm were added to the composite sol and rapidly stirred uniformly to form a slurry C with a solid content of 70%;

the slurry C was subjected to spray drying and then to heat treatment at 450° C. for 6 h, and the lithium-rich manganese-based cathode material core obtained a first coating layer on its surface, so as to obtain a product D.

The product D and the second coating material were dispersed into pure water by stirring to form a mixed slurry E. The mixed slurry E was pumped into a high-pressure homogenizing mixer at a pressure of 800 Pa and homogenized at a pressure of 50 MPa for 1 min to obtain a mixed slurry F with a solid content of 45%.

The mixed slurry F was spray-dried in a spray-drying machine, and then sufficiently dried at 80° C. to obtain the target product, i.e., the high-performance lithium-rich manganese-based cathode material.

In steps (1)-(3), based on a mass of the lithium-rich manganese-based cathode material being 100%, a mass of the first coating material was 3%, and a mass of the second coating material was 0.01%. A mass ratio of the Al—Zr—Ce—La complex oxide and the n-type thermoelectric material was 0.5:1.

(4) Electrochemical performance test:

The button cell was tested according to the method in Example 1. It was learned from the test and analysis that the high-performance lithium-rich manganese-based cathode material prepared in this example had a discharge specific capacity of 275 mAh/g at a current density of 30 mA/g, a discharge specific capacity of 139 mAh/g at a 5C rate, and a capacity retention of 83% after 150 cycles, showing excellent electrochemical performance.

### Example 3

(1) A lithium-rich manganese-based cathode material was prepared according to a molecular formula of Li1.2Mn0.57Ni0.08Co0.15O2, and an n-type thermoelectric material was prepared according to a molecular formula of Ca0.99Bi0.01MnO3.

(2) Preparation of second coating material:

Graphene was dispersed into a chloroform solution of ferric chloride, subjected to ultrasonic treatment at a power of 300 W, added with a thiophene monomer, and subjected to ultrasonic treatment again until the total period of ultrasonic treatment reached 1 h; the dispersion system was added with ammonium persulfate as an initiator which was 2 times the mass of thiophene monomer, hydroxylated multi-walled carbon nanotubes with an inner diameter of 7 nm and a length of 20 nm, a hydrogen-containing lithium-titanium-oxygen compound of Li1.81H0.19Ti2O5·3H2O, and molybdenum disulfide, then subjected to polymerization reaction in an ice-water bath for 20 h accompanied by stirring at a rate of 1000 r/min, and dried under vacuum at 65° C. to obtain a coating material having a three-dimensional nano-network layered structure which was prepared from the polythiophene/graphene/carbon nanotube composite material, the hydrogen-containing lithium-titanium-oxygen compound of Li1.81H0.19Ti2O5·3H2O and molybdenum disulfide by in situ polymerization. The product B was subjected to heat treatment at 400° C. for 4 h with ammonia gas as a nitrogen source at a flow rate of 130 sccm for chemical vapor deposition to obtain a second coating material. In the second coating material, a mass ratio of the polythiophene, graphene, and carbon nanotubes was 2:2:6, and a mass ratio of the nitrogen-doped composite carbon material, nitrogen-doped hydrogen-containing lithium-titanium-oxygen compound, and nitrogen-doped molybdenum disulfide was 3:3:4.

(3) Preparation of high-performance lithium-rich manganese-based cathode material:

A composite sol of Al, Zr, Ce and La was prepared in accordance with a molar ratio of Al, Zr, Ce and La being 5:2:2:1, and Li1.2Mn0.57Ni0.08Co0.15O2 and Ca0.99Bi0.01MnO3 with primary particle sizes of 0.2 μm were added to the composite sol and rapidly stirred uniformly to form a slurry C with a solid content of 60%;

the slurry C was subjected to spray drying and then to heat treatment at 500° C. for 4 h, and the lithium-rich manganese-based cathode material core obtained a first coating layer on its surface, so as to obtain a product D.

The product D and the second coating material were dispersed into anhydrous ethanol by stirring to form a mixed slurry E. The mixed slurry E was pumped into a high-pressure homogenizing mixer at a pressure of 600 Pa and homogenized at a pressure of 210 MPa for 15 min to obtain a mixed slurry F with a solid content of 65%.

The mixed slurry F was spray-dried in a spray-drying machine, and then sufficiently dried at 80° C. to obtain the target product, i.e., the high-performance lithium-rich manganese-based cathode material.

In steps (1)-(3), based on a mass of the lithium-rich manganese-based cathode material being 100%, a mass of the first coating material was 2%, and a mass of the second coating material was 3%. A mass ratio of the Al—Zr—Ce—La complex oxide and the n-type thermoelectric material was 0.3:1.

(4) Electrochemical performance test:

The button cell was tested according to the method in Example 1. It was learned from the test and analysis that the high-performance lithium-rich manganese-based cathode material prepared in this example had a discharge specific capacity of 277 mAh/g at a current density of 30 mA/g, a discharge specific capacity of 126 mAh/g at a 5C rate, and a capacity retention of 78% after 150 cycles, showing excellent electrochemical performance.

### Example 4

(1) A lithium-rich manganese-based cathode material was prepared according to a molecular formula of Li1.2Mn0.64Ni0.08Co0.08O2, and an n-type thermoelectric material was prepared according to a molecular formula of CaMnO3.

(2) Preparation of second coating material:

Graphene was dispersed into a chloroform solution of ferric chloride, subjected to ultrasonic treatment at a power of 200 W, added with a pyrrole monomer, and subjected to ultrasonic treatment again until the total period of ultrasonic treatment reached 1 h; the dispersion system was added with ammonium persulfate as an initiator which was 1.5 times the mass of pyrrole monomer, hydroxylated multi-walled carbon nanotubes with an inner diameter of 6 nm and a length of 40 nm, a hydrogen-containing lithium-titanium-oxygen compound of Li1.81H0.19Ti2O5·4H2O, and molybdenum disulfide, then subjected to polymerization reaction in an ice-water bath for 15 h accompanied by stirring at a rate of 2000 r/min, and dried under vacuum at 60° C. to obtain a coating material having a three-dimensional nano-network layered structure which was prepared from the polypyrrole/graphene/carbon nanotube composite material, the hydrogen-containing lithium-titanium-oxygen compound of Li1.81H0.19Ti2O5·4H2O and molybdenum disulfide by in situ polymerization. The product B was subjected to heat treatment at 350° C. for 4.5 h with ammonia gas as a nitrogen source at a flow rate of 40 sccm for chemical vapor deposition to obtain a second coating material. In the second coating material, a mass ratio of the polypyrrole, graphene, and carbon nanotubes was 1:3:6, and a mass ratio of the nitrogen-doped composite carbon material, nitrogen-doped hydrogen-containing lithium-titanium-oxygen compound, and nitrogen-doped molybdenum disulfide was 3:4:3.

(3) Preparation of high-performance lithium-rich manganese-based cathode material:

A composite sol of Al, Zr, Ce and La was prepared in accordance with a molar ratio of Al, Zr, Ce and La being 6:1:2:1, and Li1.2Mn0.64Ni0.08Co0.08O2 and CaMnO3 with primary particle sizes of 0.8 μm were added to the composite sol and rapidly stirred uniformly to form a slurry C with a solid content of 55%.

The slurry C was subjected to spray drying and then to heat treatment at 470° C. for 3.5 h, and the lithium-rich manganese-based cathode material core obtained a first coating layer on its surface, so as to obtain a product D.

The product D and the second coating material were dispersed into anhydrous ethanol by stirring to form a mixed slurry E. The mixed slurry E was pumped into a high-pressure homogenizing mixer at a pressure of 700 Pa and homogenized at a pressure of 150 MPa for 6 min to obtain a mixed slurry F with a solid content of 60%.

The mixed slurry F was spray-dried in a spray-drying machine, and then sufficiently dried at 80° C. to obtain the target product, i.e., the high-performance lithium-rich manganese-based cathode material.

In steps (1)-(3), based on a mass of the lithium-rich manganese-based cathode material being 100%, a mass of the first coating material was 4%, and a mass of the second coating material was 0.5%. A mass ratio of the Al—Zr—Ce—La complex oxide and the n-type thermoelectric material was 0.05:1.

(4) Electrochemical performance test:

The button cell was tested according to the method in Example 1. It was learned from the test and analysis that the high-performance lithium-rich manganese-based cathode material prepared in this example had a discharge specific capacity of 268 mAh/g at a current density of 30 mA/g, a discharge specific capacity of 124 mAh/g at a 5C rate, and a capacity retention of 75% after 150 cycles, showing excellent electrochemical performance.

### Example 5

(1) A lithium-rich manganese-based cathode material was prepared according to a molecular formula of Li1.2Mn0.48Ni0.16Co0.16O2, and an n-type thermoelectric material was prepared according to a molecular formula of CaMnO3.

(2) Preparation of second coating material:

Graphene was dispersed into a chloroform solution of ferric chloride, subjected to ultrasonic treatment at a power of 150 W, added with a pyrrole monomer, and subjected to ultrasonic treatment again until the total period of ultrasonic treatment reached 1.5 h; the dispersion system was added with ammonium persulfate as an initiator which was 1.2 times the mass of pyrrole monomer, hydroxylated multi-walled carbon nanotubes with an inner diameter of 10 nm and a length of 35 nm, a hydrogen-containing lithium-titanium-oxygen compound of Li1.81H0.19Ti2O5·H2O, and molybdenum disulfide, then subjected to polymerization reaction in an ice-water bath for 25 h accompanied by stirring at a rate of 1500 r/min, and dried under vacuum at 60° C. to obtain a coating material having a three-dimensional nano-network layered structure which was prepared from the polypyrrole/graphene/carbon nanotube composite material, the hydrogen-containing lithium-titanium-oxygen compound of Li1.81H0.19Ti2O5·H2O and molybdenum disulfide by in situ polymerization. The product B was subjected to heat treatment at 400° C. for 2.5 h with ammonia gas as a nitrogen source at a flow rate of 20 sccm for chemical vapor deposition to obtain a second coating material. In the second coating material, a mass ratio of the polypyrrole, graphene, and carbon nanotubes was 2:5:3, and a mass ratio of the nitrogen-doped composite carbon material, nitrogen-doped hydrogen-containing lithium-titanium-oxygen compound, and nitrogen-doped molybdenum disulfide was 3:4:3.

(3) Preparation of high-performance lithium-rich manganese-based cathode material:

A composite sol of Al, Zr, Ce and La was prepared in accordance with a molar ratio of Al, Zr, Ce and La being 5:3:2:1, and Li1.2Mn0.48Ni0.16Co0.16O2 and CaMnO3 with primary particle sizes of 0.3 μm were added to the composite sol and rapidly stirred uniformly to form a slurry C with a solid content of 65%.

The slurry C was subjected to spray drying and then to heat treatment at 550° C. for 1 h, and the lithium-rich manganese-based cathode material core obtained a first coating layer on its surface, so as to obtain a product D.

The product D and the second coating material were dispersed into acetone by stirring to form a mixed slurry E. The mixed slurry E was pumped into a high-pressure homogenizing mixer at a pressure of 650 Pa and homogenized at a pressure of 200 MPa for 12 min to obtain a mixed slurry F with a solid content of 55%. The mixed slurry F was spray-dried in a spray-drying machine, and then sufficiently dried at 80° C. to obtain the target product, i.e., the high-performance lithium-rich manganese-based cathode material.

In steps (1)-(3), based on a mass of the lithium-rich manganese-based cathode material being 100%, a mass of the first coating material was 0.1%, and a mass of the second coating material was 0.5%. A mass ratio of the Al—Zr—Ce—La complex oxide and the n-type thermoelectric material was 0.3:1.

(4) Electrochemical performance test:

The button cell was tested according to the method in Example 1. It was learned from the test and analysis that the high-performance lithium-rich manganese-based cathode material prepared in this example had a discharge specific capacity of 269 mAh/g at a current density of 30 mA/g, a discharge specific capacity of 121 mAh/g at a 5C rate, and a capacity retention of 77% after 150 cycles, showing excellent electrochemical performance.

### Example 6

(1) A lithium-rich manganese-based cathode material was prepared according to a molecular formula of Li1.2Mn0.48Ni0.16Co0.16O2, and an n-type thermoelectric material was prepared according to a molecular formula of Ca0.95Bi0.05MnO3.

(2) Preparation of second coating material:

Graphene was dispersed into a chloroform solution of ferric chloride, subjected to ultrasonic treatment at a power of 250 W, added with a pyrrole monomer, and subjected to ultrasonic treatment again until the total period of ultrasonic treatment reached 1 h; the dispersion system was added with ammonium persulfate as an initiator which was 1.3 times the mass of pyrrole monomer, hydroxylated multi-walled carbon nanotubes with an inner diameter of 8 nm and a length of 28 nm, a hydrogen-containing lithium-titanium-oxygen compound of Li1.81H0.19Ti2O5·5H2O, and molybdenum disulfide, then subjected to polymerization reaction in an ice-water bath for 28 h accompanied by stirring at a rate of 1800 r/min, and dried under vacuum at 60° C. to obtain a coating material having a three-dimensional nano-network layered structure which was prepared from the polypyrrole/graphene/carbon nanotube composite material, the hydrogen-containing lithium-titanium-oxygen compound of Li1.81H0.19Ti2O5·5H2O and molybdenum disulfide by in situ polymerization. The product B was subjected to heat treatment at 400° C. for 2.5 h with ammonia gas as a nitrogen source at a flow rate of 450 sccm for chemical vapor deposition to obtain a second coating material. In the second coating material, a mass ratio of the polypyrrole, graphene, and carbon nanotubes was 2:5:3, and a mass ratio of the nitrogen-doped composite carbon material, nitrogen-doped hydrogen-containing lithium-titanium-oxygen compound, and nitrogen-doped molybdenum disulfide was 3:4:3.

(3) Preparation of high-performance lithium-rich manganese-based cathode material:

A composite sol of Al, Zr, Ce and La was prepared in accordance with a molar ratio of Al, Zr, Ce and La being 5:3:1:1, and Li1.2Mn0.48Ni0.16Co0.16O2 and Ca0.95Bi0.05MnO3 with primary particle sizes of 0.3 μm were added to the composite sol and rapidly stirred uniformly to form a slurry C with a solid content of 65%.

The slurry C was subjected to spray drying and then to heat treatment at 500° C. for 1.5 h, and the lithium-rich manganese-based cathode material core obtained a first coating layer on its surface, so as to obtain a product D.

The product D and the second coating material were dispersed into acetone by stirring to form a mixed slurry E. The mixed slurry E was pumped into a high-pressure homogenizing mixer at a pressure of 750 Pa and homogenized at a pressure of 180 MPa for 9 min to obtain a mixed slurry F with a solid content of 58%.

The mixed slurry F was spray-dried in a spray-drying machine, and then sufficiently dried at 80° C. to obtain the target product, i.e., the high-performance lithium-rich manganese-based cathode material.

In steps (1)-(3), based on a mass of the lithium-rich manganese-based cathode material being 100%, a mass of the first coating material was 2.2%, and a mass of the second coating material was 3.5%. A mass ratio of the Al—Zr—Ce—La complex oxide and the n-type thermoelectric material was 0.4:1.

(4) Electrochemical performance test:

The button cell was tested according to the method in Example 1. It was learned from the test and analysis that the high-performance lithium-rich manganese-based cathode material prepared in this example had a discharge specific capacity of 274 mAh/g at a current density of 30 mA/g, a discharge specific capacity of 136 mAh/g at a 5C rate, and a capacity retention of 80% after 150 cycles, showing excellent electrochemical performance.

### Example 7

(1) A lithium-rich manganese-based cathode material was prepared according to a molecular formula of Li1.2Mn0.6Ni0.15Al0.05O2, and an n-type thermoelectric material was prepared according to a molecular formula of Li0.1P0.2NbO2.

(2) Preparation of second coating material:

Graphene was dispersed into a chloroform solution of ferric chloride, subjected to ultrasonic treatment at a power of 250 W, added with a thiophene monomer, and subjected to ultrasonic treatment again until the total period of ultrasonic treatment reached 40 min; the dispersion system was added with ammonium persulfate as an initiator which was 1.3 times the mass of pyrrole monomer, hydroxylated multi-walled carbon nanotubes with an inner diameter of 7 nm and a length of 15 nm, a hydrogen-containing lithium-titanium-oxygen compound of Li1.81H0.19Ti2O5·3H2O, and molybdenum disulfide, then subjected to polymerization reaction in an ice-water bath for 22 h accompanied by stirring at a rate of 1200 r/min, and dried under vacuum at 60° C. to obtain a coating material having a three-dimensional nano-network layered structure which was prepared from the polythiophene/graphene/carbon nanotube composite material, the hydrogen-containing lithium-titanium-oxygen compound of Li1.81H0.19Ti2O5·3H2O and molybdenum disulfide by in situ polymerization. The product B was subjected to heat treatment at 520° C. for 1.8 h with ammonia gas as a nitrogen source at a flow rate of 350 sccm for chemical vapor deposition to obtain a second coating material. In the second coating material, a mass ratio of the polythiophene, graphene, and carbon nanotubes was 1:4:5, and a mass ratio of the nitrogen-doped composite carbon material, nitrogen-doped hydrogen-containing lithium-titanium-oxygen compound, and nitrogen-doped molybdenum disulfide was 2:4:4.

(3) Preparation of high-performance lithium-rich manganese-based cathode material:

A composite sol of Al, Zr, Ce and La was prepared in accordance with a molar ratio of Al, Zr, Ce and La being 5:2:2:1, and Li1.2Mn0.6Ni0.15Al0.05O2 and Li0.1P0.2NbO2 with primary particle sizes of 0.3 μm were added to the composite sol and rapidly stirred uniformly to form a slurry C with a solid content of 50%.

The slurry C was subjected to spray drying and then to heat treatment at 480° C. for 3.5 h, and the lithium-rich manganese-based cathode material core obtained a first coating layer on its surface, so as to obtain a product D.

The product D and the second coating material were dispersed into diethyl ether by stirring to form a mixed slurry E. The mixed slurry E was pumped into a high-pressure homogenizing mixer at a pressure of 650 Pa and homogenized at a pressure of 70 MPa for 25 min to obtain a mixed slurry F with a solid content of 58%.

The mixed slurry F was spray-dried in a spray-drying machine, and then sufficiently dried at 80° C. to obtain the target product, i.e., the high-performance lithium-rich manganese-based cathode material.

In steps (1)-(3), based on a mass of the lithium-rich manganese-based cathode material being 100%, a mass of the first coating material was 1.6%, and a mass of the second coating material was 1.2%. A mass ratio of the Al—Zr—Ce—La complex oxide and the n-type thermoelectric material was 0.07:1.

(4) Electrochemical performance test:

The button cell was tested according to the method in Example 1. It was learned from the test and analysis that the high-performance lithium-rich manganese-based cathode material prepared in this example had a discharge specific capacity of 271 mAh/g at a current density of 30 mA/g, a discharge specific capacity of 133 mAh/g at a 5C rate, and a capacity retention of 82% after 150 cycles, showing excellent electrochemical performance.

### Example 8

(1) A lithium-rich manganese-based cathode material was prepared according to a molecular formula of Li1.2Mn0.55Ni0.15Co0.1O2, and an n-type thermoelectric material was prepared according to a molecular formula of (Nd0.8Li1.5)TiO3.

(2) Preparation of second coating material:

Graphene was dispersed into a chloroform solution of ferric chloride, subjected to ultrasonic treatment at a power of 250 W, added with a thiophene monomer, and subjected to ultrasonic treatment again until the total period of ultrasonic treatment reached 50 min; the dispersion system was added with ammonium persulfate as an initiator which was 1.7 times the mass of pyrrole monomer, hydroxylated multi-walled carbon nanotubes with an inner diameter of 10 nm and a length of 23 nm, a hydrogen-containing lithium-titanium-oxygen compound of Li1.81H0.19Ti2O5·2H2O, and molybdenum disulfide, then subjected to polymerization reaction in an ice-water bath for 25 h accompanied by stirring at a rate of 2200 r/min, and dried under vacuum at 60° C. to obtain a coating material having a three-dimensional nano-network layered structure which was prepared from the polythiophene/graphene/carbon nanotube composite material, the hydrogen-containing lithium-titanium-oxygen compound of Li1.81H0.19Ti2O5·2H2O and molybdenum disulfide by in situ polymerization. The product B was subjected to heat treatment at 470° C. for 2 h with ammonia gas as a nitrogen source at a flow rate of 450 sccm for chemical vapor deposition to obtain a second coating material. In the second coating material, a mass ratio of the polythiophene, graphene, and carbon nanotubes was 3:5:2, and a mass ratio of the nitrogen-doped composite carbon material, nitrogen-doped hydrogen-containing lithium-titanium-oxygen compound, and nitrogen-doped molybdenum disulfide was 4:2:4.

(3) Preparation of high-performance lithium-rich manganese-based cathode material:

A composite sol of Al, Zr, Ce and La was prepared in accordance with a molar ratio of Al, Zr, Ce and La being 6:1:2:1, and Li1.2Mn0.55Ni0.15Co0.1O2 and (Nd0.8Li1.5)TiO3 with primary particle sizes of 0.3 μm were added to the composite sol and rapidly stirred uniformly to form a slurry C with a solid content of 63%.

The slurry C was subjected to spray drying and then to heat treatment at 540° C. for 3.8 h, and the lithium-rich manganese-based cathode material core obtained a first coating layer on its surface, so as to obtain a product D.

The product D and the second coating material were dispersed into benzene by stirring to form a mixed slurry E. The mixed slurry E was pumped into a high-pressure homogenizing mixer at a pressure of 720 Pa and homogenized at a pressure of 175 MPa for 17 min to obtain a mixed slurry F with a solid content of 53%.

The mixed slurry F was spray-dried in a spray-drying machine, and then sufficiently dried at 80° C. to obtain the target product, i.e., the high-performance lithium-rich manganese-based cathode material.

In steps (1)-(3), based on a mass of the lithium-rich manganese-based cathode material being 100%, a mass of the first coating material was 0.3%, and a mass of the second coating material was 4.3%. A mass ratio of the Al—Zr—Ce—La complex oxide and the n-type thermoelectric material was 0.23:1.

(4) Electrochemical performance test:

The button cell was tested according to the method in Example 1. It was learned from the test and analysis that the high-performance lithium-rich manganese-based cathode material prepared in this example had a discharge specific capacity of 273.5 mAh/g at a current density of 30 mA/g, a discharge specific capacity of 135 mAh/g at a 5C rate, and a capacity retention of 81% after 150 cycles, showing excellent electrochemical performance.

### Example 9

(1) A lithium-rich manganese-based cathode material was prepared according to a molecular formula of Li1.2Mn0.57Ni0.08Cr0.15O2, and an n-type thermoelectric material was prepared according to a molecular formula of Ca0.9Bi0.1MnO3.

(2) Preparation of second coating material:

Graphene was dispersed into a chloroform solution of ferric chloride, subjected to ultrasonic treatment at a power of 270 W, added with an aniline monomer, and subjected to ultrasonic treatment again until the total period of ultrasonic treatment reached 55 min; the dispersion system was added with ammonium persulfate as an initiator which was 1.7 times the mass of pyrrole monomer, hydroxylated multi-walled carbon nanotubes with an inner diameter of 11 nm and a length of 15 nm, a hydrogen-containing lithium-titanium-oxygen compound of Li1.81H0.19Ti2O5·2H2O, and molybdenum disulfide, then subjected to polymerization reaction in an ice-water bath for 24 h accompanied by stirring at a rate of 2600 r/min, and dried under vacuum at 60° C. to obtain a coating material having a three-dimensional nano-network layered structure which was prepared from the polyaniline/graphene/carbon nanotube composite material, the hydrogen-containing lithium-titanium-oxygen compound of Li1.81H0.19Ti2O5·2H2O and molybdenum disulfide by in situ polymerization. The product B was subjected to heat treatment at 420° C. for 3 h with ammonia gas as a nitrogen source at a flow rate of 200 sccm for chemical vapor deposition to obtain a second coating material. In the second coating material, a mass ratio of the polyaniline, graphene, and carbon nanotubes was 1:4:5, and a mass ratio of the nitrogen-doped composite carbon material, nitrogen-doped hydrogen-containing lithium-titanium-oxygen compound, and nitrogen-doped molybdenum disulfide was 2:4:4.

(3) Preparation of high-performance lithium-rich manganese-based cathode material:

A composite sol of Al, Zr, Ce and La was prepared in accordance with a molar ratio of Al, Zr, Ce and La being 5:3:1:1, and Li1.2Mn0.57Ni0.08Cr0.15O2 and Ca0.9Bi0.1MnO3 with primary particle sizes of 0.4 μm were added to the composite sol and rapidly stirred uniformly to form a slurry C with a solid content of 47%.

The slurry C was subjected to spray drying and then to heat treatment at 510° C. for 5 h, and the lithium-rich manganese-based cathode material core obtained a first coating layer on its surface, so as to obtain a product D.

The product D and the second coating material were dispersed into benzene by stirring to form a mixed slurry E. The mixed slurry E was pumped into a high-pressure homogenizing mixer at a pressure of 720 Pa and homogenized at a pressure of 185 MPa for 14 min to obtain a mixed slurry F with a solid content of 53%.

The mixed slurry F was spray-dried in a spray-drying machine, and then sufficiently dried at 80° C. to obtain the target product, i.e., the high-performance lithium-rich manganese-based cathode material.

In steps (1)-(3), based on a mass of the lithium-rich manganese-based cathode material being 100%, a mass of the first coating material was 2.3%, and a mass of the second coating material was 3.2%. A mass ratio of the Al—Zr—Ce—La complex oxide and the n-type thermoelectric material was 0.33:1.

(4) Electrochemical performance test:

The button cell was tested according to the method in Example 1. It was learned from the test and analysis that the high-performance lithium-rich manganese-based cathode material prepared in this example had a discharge specific capacity of 270.5 mAh/g at a current density of 30 mA/g, a discharge specific capacity of 137 mAh/g at a 5C rate, and a capacity retention of 78% after 150 cycles, showing excellent electrochemical performance.

### Example 10

The material was prepared and tested for electrochemical performance according to the preparation method and electrochemical testing method in Example 1; the only difference lies in that, in this example, the composite sol of Al, Zr, Ce and La was prepared in accordance with a molar ratios of Al, Zr, Ce and La being 1:4:3:2. It was learned from the test and analysis that the high-performance lithium-rich manganese-based cathode material prepared in this example had a discharge specific capacity of 249 mAh/g at a current density of 30 mA/g, a discharge specific capacity of 121 mAh/g at a 5C rate, and a capacity retention of 72% after 150 cycles.

As can be seen from the comparison between Example 1 and Example 10, the electrochemical performance of the cathode material can be optimized by optimizing the element ratio of the Al—Zr—Ce—La complex oxide.

### Example 11

The material was prepared and tested for electrochemical performance according to the preparation method and electrochemical testing method in Example 1; the only difference lies in that, in this example, only the slurry after the primary coating was subjected to spray drying for granulation, while the slurry after the secondary coating was not subjected to spray drying for granulation but was directly dried in a common oven. It was learned from the test and analysis that the high-performance lithium-rich manganese-based cathode material prepared in this example had a discharge specific capacity of 261 mAh/g at a current density of 30 mA/g, a discharge specific capacity of 119 mAh/g at a 5C rate, and a capacity retention of 75% after 150 cycles.

### Example 12

The material was prepared and tested for electrochemical performance according to the preparation method and electrochemical testing method in Example 1; the only difference lies in that, in this example, neither the slurry after the primary coating nor the slurry after the secondary coating was not subjected to spray drying for granulation but was directly dried in a common oven. It was learned from the test and analysis that the high-performance lithium-rich manganese-based cathode material prepared in this example had a discharge specific capacity of 203 mAh/g at a current density of 30 mA/g, a discharge specific capacity of 105 mAh/g at a 5C rate, and a capacity retention of 69% after 150 cycles.

As can be seen from the comparison between Example 1 and Examples 11-12, the two spray-drying processes play a very important role in improving the performance of the cathode material.

### Example 13

The material was prepared and tested for electrochemical performance according to the preparation method and electrochemical testing method in Example 1; the only difference lies in that, in this example, a mass ratio of the Al—Zr—Ce—La complex oxide and the n-type thermoelectric material was 0.6:1; the performance was inferior to that of Example 1 due to the excessive n-type thermoelectric material. It was learned from the test and analysis that the high-performance lithium-rich manganese-based cathode material prepared in this example had a discharge specific capacity of 238 mAh/g at a current density of 30 mA/g, a discharge specific capacity of 123 mAh/g at a 5C rate, and a capacity retention of 74% after 150 cycles.

As can be seen from the comparison between Example 1 and Example 13, there is a preferred range of the amount of the n-type thermoelectric material, and the preferred range can better improve the electrochemical performance of the cathode material.

### Example 14

This example differs from Example 2 in that the second coating material added in this example did not contain carbon nanotubes, and the others were the same as in Example 2.

The lithium-rich manganese-based cathode material prepared in this comparative example had a discharge specific capacity of 248 mAh/g at a current density of 30 mA/g, a discharge specific capacity of 103.5 mAh/g at a 5C rate, and a capacity retention of 73% after 150 cycles. Because the second coating material added in this comparative example does not contain carbon nanotubes, the second coating material does not obtain a three-dimensional nano-network structure, and thus cannot further shorten the lithium-ion transport path and accordingly cannot further accelerate the lithium-ion transport rate, resulting in a reduction in the discharge specific capacity and rate capability of the material.

### Example 15

This example differs from Example 5 in that the mixed slurry E in this example was not homogenized by the high-pressure homogenizing mixer but only stirred, and the others were the same as in Example 5.

The lithium-rich manganese-based cathode material prepared in this comparative example had a discharge specific capacity of 243 mAh/g at a current density of 30 mA/g, a discharge specific capacity of 110.5 mAh/g at a 5C rate, and a capacity retention of 70% after 150 cycles. The lithium-rich manganese-based cathode material coated with the first coating material and the second coating material cannot be uniformly dispersed just by stirring; the primary particle obtained without high-pressure homogenization has a larger size, the second coating material cannot be uniformly coated on the surface of the lithium-rich manganese-based cathode material, the network structure of the second coating material cannot be formed among the primary particles, and therefore, the lithium-rich manganese-based cathode material cannot be improved in the electrical conductivity, discharge specific capacity and cycling stability.

### Example 16

This example differs from Example 8 in that the composite carbon material, hydrogen-containing lithium-titanium-oxygen compound, and molybdenum disulfide were not doped with nitrogen in this example, and the others were the same as in Example 8.

The lithium-rich manganese-based cathode material prepared in this comparative example had a discharge specific capacity of 251 mAh/g at a current density of 30 mA/g, a discharge specific capacity of 126 mAh/g at a 5C rate, and a capacity retention of 57% after 150 cycles. After the composite carbon material, hydrogen-containing lithium-titanium-oxygen compound and molybdenum disulfide are doped by nitrogen, the lithium-rich manganese-based cathode material can be improved in rate capability and cycling stability; the step of nitrogen doping is not performed in this comparative example, which eventually results in the deteriorated rate capability and stability for the obtained lithium-rich manganese-based cathode material.

### Comparative Example 1

This comparative example differs from Example 1 in that the n-type thermoelectric material of Li0.3P0.1NbO2 was not added in this comparative example, and the others were the same as in Example 1.

The lithium-rich manganese-based cathode material prepared in this comparative example had a discharge specific capacity of 260 mAh/g at a current density of 30 mA/g, a discharge specific capacity of 137 mAh/g at a 5C rate, and a capacity retention of 61% after 150 cycles. The cycling stability of this comparative example is deteriorated due to the absence of n-type thermoelectric material.

### Comparative Example 2

This comparative example differs from Example 2 in that the second coating material was not added in this comparative example, and the others were the same as in Example 2.

The lithium-rich manganese-based cathode material prepared in this comparative example had a discharge specific capacity of 218 mAh/g at a current density of 30 mA/g, a discharge specific capacity of 115 mAh/g at a 5C rate, and a capacity retention of 56% after 150 cycles. Due to the absence of second coating material, the discharge specific capacity of the material of this comparative example is significantly reduced, and the rate capability and cycling stability are deteriorated.

### Comparative Example 3

This comparative example differs from Example 2 in that the second coating material added in this comparative example did not contain the hydrogen-containing lithium-titanium-oxygen compound, and the others were the same as in Example 2.

The lithium-rich manganese-based cathode material prepared in this comparative example had a discharge specific capacity of 262 mAh/g at a current density of 30 mA/g, a discharge specific capacity of 122 mAh/g at a 5C rate, and a capacity retention of 67% after 150 cycles. Because the second coating material added in this comparative example does not contain the hydrogen-containing lithium-titanium-oxygen compound, the rate capability and cycling stability of the material are deteriorated.

### Comparative Example 4

This comparative example differs from Example 2 in that the second coating material added in this comparative example did not contain polyaniline, and the others were the same as in Example 2.

The lithium-rich manganese-based cathode material prepared in this comparative example had a discharge specific capacity of 237 mAh/g at a current density of 30 mA/g, a discharge specific capacity of 134 mAh/g at a 5C rate, and a capacity retention of 75% after 150 cycles. Because the second coating material added in this comparative example does not contain polyaniline, the discharge specific capacity of the material is reduced.

### Comparative Example 5

This comparative example differs from Example 3 in that the first coating material was not added in this comparative example, and the others were the same as in Example 3.

The lithium-rich manganese-based cathode material prepared in this comparative example had a discharge specific capacity of 268 mAh/g at a current density of 30 mA/g, a discharge specific capacity of 120 mAh/g at a 5C rate, and a capacity retention of 49% after 150 cycles. In this comparative example, due to the absence of first coating material, the lithium-rich manganese-based cathode material particle does not have the complex oxide protective layer on its surface, and the material cannot be effectively protected from the corrosion of electrolyte during the charging and discharging process, which results in a significant deterioration in the cycling stability of the lithium-rich manganese-based cathode material.

### Comparative Example 6

This comparative example differs from Example 3 in that the primary particle sizes of Li1.2Mn0.57Ni0.08Co0.15O2 and Ca0.99Bi0.01MnO3 were 10 μm, and the others were the same as in Example 3.

The lithium-rich manganese-based cathode material prepared in this comparative example had a discharge specific capacity of 251 mAh/g at a current density of 30 mA/g, a discharge specific capacity of 107 mAh/g at a 5C rate, and a capacity retention of 77% after 150 cycles. In this example, because the primary particle sizes of Li1.2Mn0.57Ni0.08Co0.15O2 and Ca0.99Bi0.01MnO3 are 10 μm, which is much larger than 0.2 μm, the lithium-ion transport path is longer during the charging and discharging process, and thereby the discharge specific capacity and rate capability of the lithium-rich manganese-based cathode material are significantly reduced.

### Comparative Example 7

This comparative example differs from Example 6 in that molybdenum disulfide was not added in this comparative example, and the others were the same as in Example 6.

The lithium-rich manganese-based cathode material prepared in this comparative example had a discharge specific capacity of 246 mAh/g at a current density of 30 mA/g, a discharge specific capacity of 125 mAh/g at a 5C rate, and a capacity retention of 74% after 150 cycles. Because the molybdenum ion has larger radius than manganese and at the same time can contribute Mo4+/6+ in the charging and discharging process, the addition of an appropriate amount of molybdenum disulfide can improve the capacity of the material, expand the lattice parameter of the material, and improve the rate capability; meanwhile, the participation of Mo4+/6+ can reduce the oxidation state of oxygen ion and the redox amount of irreversible oxygen, and improve the stability of the structure and electrolyte. In this comparative example, without molybdenum disulfide, the lithium-rich manganese-based cathode material cannot be improved in the rate capability, discharge specific capacity and cycling stability.

### Comparative Example 8

This comparative example differs from Example 7 in that, in this comparative example, the lithium-rich manganese-based cathode material coated with the first coating material was heated at 680° C. for 3.5 h, instead of being heated at 480° C. for 3.5 h as in Example 7, and the others were the same as in Example 7.

The lithium-rich manganese-based cathode material prepared in this comparative example had a discharge specific capacity of 231 mAh/g at a current density of 30 mA/g, a discharge specific capacity of 94 mAh/g at a 5C rate, and a capacity retention of 70% after 150 cycles. Because the temperature at which the lithium-rich manganese-based cathode material coated with the first coating material was heated is overly high, up to 680° C., the Al—Zr—Ce—La complex oxide on the surface of the material is seriously overburned, resulting in a reduction in the specific capacity, rate capability and stability of the lithium-rich manganese-based cathode material finally obtained.

### Comparative Example 9

This comparative example differs from Example 1 only in that the Al—Zr—Ce—La complex oxide was not added in this comparative example, and the others were the same as in Example 1. It was learned from the test and analysis that the high-performance lithium-rich manganese-based cathode material prepared in this example had a discharge specific capacity of 223 mAh/g at a current density of 30 mA/g, a discharge specific capacity of 112 mAh/g at a 5C rate, and a capacity retention of 73% after 150 cycles.

### Comparative Example 10

This comparative example differs from Example 1 only in that a Mg—Ti complex oxide was added in this comparative example, instead of the Al—Zr—Ce—La complex oxide as added in Example 1, and the others were the same as in Example 1. It was learned from the test and analysis that the high-performance lithium-rich manganese-based cathode material prepared in this example had a discharge specific capacity of 235 mAh/g at a current density of 30 mA/g, a discharge specific capacity of 119 mAh/g at a 5C rate, and a capacity retention of 78% after 150 cycles.

The applicant has stated that although the detailed method of the present application is described through the above examples, the present application is not limited to the above detailed method, which means that the implementation of the present application does not necessarily depend on the above detailed method. It should be apparent to those skilled in the art that any improvements made to the present application, equivalent substitutions of various raw materials of the product, addition of adjuvant ingredients, selection of specific manners, etc., shall fall within the protection scope and disclosure scope of the present application.

1. A lithium-rich manganese-based cathode material, wherein the lithium-rich manganese-based cathode material comprises a lithium-rich manganese-based cathode material core and a shell coated on the surface of the core, the shell comprises a first coating material and a second coating material, the first coating material comprises a Al—Zr—Ce—La complex oxide and an n-type thermoelectric material, and the second coating material comprises a composite carbon material, a hydrogen-containing lithium-titanium-oxygen compound and molybdenum disulfide.

2. The lithium-rich manganese-based cathode material according to claim 1, wherein the lithium-rich manganese-based cathode material core has a structural formula of xLi₂MnO₃·(1−x)LiMO₂, wherein M is any one or a combination of at least two of Co, Ni, Fe, K, V, Cr, Ge, Nb, Mo, Zr, Al, Sr, Mg, Ti or Mn, and 0<x≤1.

3. The lithium-rich manganese-based cathode material according to claim 2, wherein M is a combination of Co, Ni and Mn.

4. The lithium-rich manganese-based cathode material according to claim 1, wherein the lithium-rich manganese-based cathode material is spherical and/or spheroidal.

5. The lithium-rich manganese-based cathode material according to claim 1, wherein in the lithium-rich manganese-based cathode material, the second coating material having a three-dimensional network structure is uniformly coated on the surface of a primary particle and/or between primary particles;
based on a mass of the lithium-rich manganese-based cathode material being 100%, a mass of the first coating material is 0.01-3%;
based on a mass of the lithium-rich manganese-based cathode material being 100%, a mass of the second coating material is 0.01-5%.

6. The lithium-rich manganese-based cathode material according to claim 1, wherein the second coating material has a three-dimensional network structure.

7. The lithium-rich manganese-based cathode material according to claim 1, wherein the hydrogen-containing lithium-titanium-oxygen compound and/or molybdenum disulfide is dispersed in situ on the surface of the composite carbon material;
a mass ratio of the composite carbon material, the hydrogen-containing lithium-titanium-oxygen compound, and the molybdenum disulfide is (2-6):(3-5):(1-5);
at least one of the composite carbon material, the hydrogen-containing lithium-titanium-oxygen compound and the molybdenum disulfide is doped with nitrogen, and preferably, the composite carbon material, the hydrogen-containing lithium-titanium-oxygen compound and the molybdenum disulfide are all doped with nitrogen.

8. The lithium-rich manganese-based cathode material according to claim 1, wherein the first coating material is coated on the surface of the core;
the second coating material is coated on the surface of the first coating material, or the second coating material is coated on the surface of the first coating material and the surface of the core.

9. A method for preparing the lithium-rich manganese-based cathode material according to claim 1, comprising the following steps:
(1) preparing a composite sol of Al, Zr, Ce and La in accordance with a stoichiometric ratio, and adding a lithium-rich manganese-based cathode material and an n-type thermoelectric material to the composite sol, so as to obtain a first slurry;
(2) subjecting the first slurry to spray drying and then heat treatment to coat a first coating material on the surface of a lithium-rich manganese-based cathode material core, so as to obtain a precursor;
(3) dispersing the precursor and a second coating material into a solvent, so as to obtain a second slurry; and
(4) subjecting the second slurry to spray drying, so as to obtain the lithium-rich manganese-based cathode material.

10. The method according to claim 9, wherein the lithium-rich manganese-based cathode material in step (1) is subjected to crushing treatment before being added to the composite sol, and a primary particle size of particles obtained from the crushing treatment is preferably 0.1-2 μm, preferably 0.2-1.5 μm, and further preferably 0.5-1.0 μm.

11. The method according to claim 9, wherein the n-type thermoelectric material in step (1) is subjected to crushing treatment before being added to the composite sol, and a primary particle size of particles obtained from the crushing treatment is preferably 0.1-2 μm, preferably 0.2-1.5 μm, and further preferably 0.5-1.0 μm.

12. The method according to claim 9, wherein the first slurry in step (1) has a solid content of 40-70%.

13. The method according to claim 9, wherein the spray drying in step (2) is performed at an inlet temperature of 150-280° C. and at an outlet temperature of 70-100° C.;
the spray drying in step (2) is performed in an air atmosphere;
the heat treatment in step (2) is performed at a temperature of 450-550° C.;
the heat treatment in step (2) is performed for a period of 3-6 h;
in step (3), the precursor and the second coating material are treated by a high pressure homogenizer at 50-210 MPa for 1-40 min before or after being dispersed into the solvent;
the solvent in step (3) comprises any one or a combination of at least two of deionized water, anhydrous ethanol, diethyl ether, acetone, tetrahydrofuran, benzene, toluene, N-methylpyrrolidone or dimethylformamide, and preferably any one or a combination of at least two of deionized water, anhydrous ethanol or acetone;
the second slurry is subjected to homogenization before the spray drying in step (4);
the homogenization is performed by a homogenizing mixer;
the homogenization is performed at a pressure of 500-800 Pa;
the homogenization is performed for a period of 1-30 min;
the second slurry after the homogenization has a solid content of 45-65%;
a step of drying is further performed after the spray drying in step (4), and the drying is performed at a temperature of 70-80° C.;
the spray drying in step (4) is performed at an inlet temperature of 150° C.-280° C. and at an outlet temperature of 70° C.-100° C.;
the spray drying in step (4) is performed under the protection of a protective gas, and the protective gas comprises any one or a combination of at least two of nitrogen, helium, argon, neon, krypton and xenon.

14. The method according to claim 9, wherein a method for preparing the second coating material in step (3) comprises the following steps:
(a) dispersing graphene into a solvent, performing ultrasonic treatment, adding a conductive polymer monomer, performing ultrasonic treatment, adding an initiator, carbon nanotubes, a hydrogen-containing lithium-titanium-oxygen compound and molybdenum disulfide, and performing polymerization reaction to obtain a product A; and
(b) subjecting the product A in step (a) to separation and then drying, so as to obtain the second coating having a three-dimensional nano-network layered structure which is prepared from the conductive polymer/graphene/carbon nanotube composite material, the hydrogen-containing lithium-titanium-oxygen compound and molybdenum disulfide by in situ polymerization;
step (c) is further performed after the drying in step (b) for nitrogen doping of the second coating material, and step (c) is: subjecting the product obtained from step (b) to heat treatment with a gaseous nitrogen source for chemical vapor deposition;
the ultrasonic treatment in step (a) is performed at a power of 50 W-600 W;
the ultrasonic treatment in step (a) is performed for a period of 30 min-2 h:
the conductive polymer monomer in step (a) comprises any one or a mixture of at least two of pyrrole, aniline or thiophene;
the solvent in step (a) comprises any one or a mixture of at least two of ethanol, deionized water, inorganic protonic acid or a chloroform solution of ferric chloride;
in step (a), the initiator is ammonium persulfate;
in step (a), the initiator is added as 0.1 times to 2 times, preferably 0.5 times to 1.5 times, a mass of the polymer monomer added;
the polymerization reaction in step (a) is performed in an ice-water bath;
the polymerization reaction in step (a) is accompanied by stirring, and the stirring is performed preferably at a rate of 500-3000 r/min;
the polymerization reaction in step (a) is performed for a period of 12 h-30 h;
the carbon nanotubes in step (a) are hydroxylated carbon nanotubes, preferably hydroxylated multi-walled carbon nanotubes;
the separation in step (b) is centrifugal separation;
the drying in step (b) is vacuum drying, and the vacuum drying is performed preferably at a temperature of 50-70° C.;
the gaseous nitrogen source in step (c) is ammonia gas;
the gaseous nitrogen source in step (c) has a flow rate of 10-500 sccm, preferably 20-400 sccm, and further preferably 40-350 sccm;
the heat treatment in step (c) is performed at a temperature of 300-700° C. preferably 350-650° C., and further preferably 400-600° C.;
the heat treatment in step (c) is performed for a period of 0.5-5 h, preferably 0.5-3 h.

15. (canceled)

16. The lithium-rich manganese-based cathode material according to claim 1, wherein in the first coating material, a mass ratio of the Al—Zr—Ce—La complex oxide and the n-type thermoelectric material is (0.01-0.5):1;
in the Al—Zr—Ce—La complex oxide, a molar ratio of Al, Zr, Ce and La is (4-7):(1-3):(1-2):1;
the n-type thermoelectric material has ion channels;
the n-type thermoelectric material comprises any one or a combination of at least two of LiₐP_{b}NbO₂, (Nd_{2/3-c}Li_{3c})TiO₃, (La_{2/3-d}Li_{3d})TiO₃ or CaₑBi_{f}MnO₃, wherein 0<a<0.4, 0<b<0.2, 0.2<c<⅔, 0.2<d<⅔, 0.5<e≤1, and 0≤f<0.5.

17. The lithium-rich manganese-based cathode material according to claim 1, in the second coating material, the composite carbon material is a conductive polymer/graphene/carbon nanotube composite material;
in the conductive polymer/graphene/carbon nanotube composite material, a mass ratio of a conductive polymer, graphene, and carbon nanotubes is (1-3):(2-5):(2-7).

18. The lithium-rich manganese-based cathode material according to claim 17, wherein in the conductive polymer/graphene/carbon nanotube composite material, the conductive polymer comprises any one or a mixture of at least two of polypyrrole, polyaniline or polythiophene, or a copolymer formed from monomers of at least two of the conductive polymers;
in the conductive polymer/graphene/carbon nanotube composite material, the graphene is formed by chemical reduction of graphene oxide.

19. The lithium-rich manganese-based cathode material according to claim 18, wherein, in the conductive polymer/graphene/carbon nanotube composite material, the carbon nanotubes are any one of single-walled carbon nanotubes or multi-walled carbon nanotubes, or a combination thereof;
preferably, in the conductive polymer/graphene/carbon nanotube composite material, the carbon nanotubes are hydroxylated carbon nanotubes;
in the conductive polymer/graphene/carbon nanotube composite material, the carbon nanotubes are hydroxylated multi-walled carbon nanotubes;
the hydroxylated multi-walled carbon nanotubes have an inner diameter of 5-12 nm, preferably 6-10 nm, and the hydroxylated multi-walled carbon nanotubes have a length of 1 nm-60 nm, preferably 1 nm-50 nm, and further preferably 1 nm-40 nm;
the conductive polymer/graphene/carbon nanotube composite material is obtained by in situ polymerization.

20. The lithium-rich manganese-based cathode material according to claim 1, wherein in the second coating material, the hydrogen-containing lithium-titanium-oxygen compound is a compound formed by the four elements of Li, H, Ti and O in any ratio;
the hydrogen-containing lithium-titanium-oxygen compound is a compound whose phase structure contains Li₄Ti₅O₁₂, TiO₂ and HₓTi_{y}O_{z} phases in any ratio, preferably a compound whose phase structure contains Li₄Ti₅O₁₂ and H₂Ti₃O₇·(H₂O·3TiO₂) phases in any ratio, wherein 0<x≤2, 0<y<3, and 0<z≤7;
the hydrogen-containing lithium-titanium-oxygen compound is Li_{1.81}H_{0.19}Ti₂O₅·mH₂O, wherein m>0.

21. A lithium-ion battery, comprising the lithium-rich manganese-based cathode material according to claim 1.
